(19) United States
(12) Patent Application Publication
(10) Pub. No.: US 2025/0191824 A1
(43) Pub. Date: Jun. 12, 2025

(54) COMMON MODE FILTER AND OPTICAL TRANSCEIVER

(71) Applicant: CIG Photonics Japan Limited, Yokohama (JP)

(72) Inventor: Takuma BAN, Tokyo (JP)

(21) Appl. No.: 18/976,821

(22) Filed: Dec. 11, 2024

(30) Foreign Application Priority Data
Dec. 12, 2023 (JP) 2023-209673

(51) Int. Cl. H01F 17/00; H04B 10/40; H04B 10/69

(52) U.S. Cl. CPC H01F 17/0013; H04B 10/40; H04B 10/697; H01F 2017/002

(57) ABSTRACT

Provided are a common mode filter in which a suppression bandwidth and a suppression ratio of a common mode are reduced, thereby enhancing a design flexibility of a differential transmission line and downsizing the common mode filter, and an optical transceiver which uses the common mode filter. The common mode filter includes: a pair of differential signal lines formed in a multilayer substrate including a dielectric layer; a ground conductor formed in a layer below the pair of differential signal lines; a resonant conductor pattern formed in one of the same layer as the ground conductor or a layer above the ground conductor, the resonant conductor pattern covering partial regions of the pair of differential signal lines in plan view; and a cover conductor pattern formed in a layer above the pair of differential signal lines, the cover conductor pattern covering the resonant conductor pattern in plan view.

### CROSS-REFERENCE TO RELATED APPLICATION

The present application claims priority from Japanese application JP 2023-209673 filed on Dec. 12, 2023, the content of which is hereby incorporated by reference into this application.

### BACKGROUND OF THE INVENTION

### 1. Field of the Invention

The present invention relates to a common mode filter and an optical transceiver.

### 2. Description of the Related Art

In high-speed data communication, a differential transmission method is widely used for the purpose of, for example, achieving a high data rate or reducing radiation loss by decreasing an amplitude of a signal voltage. In order to reduce a common mode noise to be caused by various reasons, in some cases, a common mode filter is used in a transmission line. The common mode filter is supplied in the market as an independent electronic component using a choke coil or the like so as to be used while being inserted in the differential transmission line.

In an electronic component using a differential transmission signal, an attempt has been made to achieve a common mode filter by a print pattern created in a multilayer substrate instead of using the common mode filter being an independent electronic component, for the purpose of achieving further downsizing, higher performance, and the like. In JP 2012-227887 A, there is described a differential transmission line and a communication device each including a band rejection filter region in which a common mode of a differential transmission signal is attenuated.

### SUMMARY OF THE INVENTION

The invention disclosed in the present application has various aspects, and the outline of typical ones of those aspects is as follows.

(1) There is provided a common mode filter including: a pair of differential signal lines formed in a multilayer substrate including a dielectric layer; a ground conductor formed in a layer below the pair of differential signal lines; a resonant conductor pattern formed in one of the same layer as the ground conductor or a layer above the ground conductor, the resonant conductor pattern covering partial regions of the pair of differential signal lines in plan view and being connected to the ground conductor; and a cover conductor pattern formed in a layer above the pair of differential signal lines, the cover conductor pattern covering the resonant conductor pattern in plan view and being connected to the ground conductor.

(2) In the common mode filter according to Item (1), the resonant conductor pattern includes a plurality of patterns that are different from each other in one of a geometric shape or a connection position relative to the ground conductor.

(3) In the common mode filter according to Item (2), in any two patterns included in the plurality of patterns, a distance in plan view between a connection position to the ground conductor in one pattern and a connection position to the ground conductor in another pattern is shorter than ⅜ of a resonant wavelength of each of the two patterns.

(4) In the common mode filter according to Item (2), one pattern and another pattern included in the plurality of patterns are formed in layers different from each other, and have at least parts overlapping each other in plan view.

(5) In the common mode filter according to Item (2), one pattern included in the plurality of patterns is formed in a layer below the pair of differential signal lines, and another pattern included in the plurality of patterns is formed in a layer above the pair of differential signal lines.

(6) In the common mode filter according to Item (5), the one pattern is connected to the ground conductor through a via, and the another pattern is connected to the cover conductor pattern through a via.

(7) The common mode filter according to Item (1) further includes a sub-ground conductor pattern formed in the same layer as the resonant conductor pattern, the sub-ground conductor pattern surrounding the resonant conductor pattern and being connected to the ground conductor, and the resonant conductor pattern is separated from the sub-ground conductor pattern with an insulating gap provided therebetween, and is isolated from the sub-ground conductor pattern within the same layer.

(8) The common mode filter according to Item (1) further includes a sub-ground conductor pattern formed in the same layer as the resonant conductor pattern, the sub-ground conductor pattern surrounding the resonant conductor pattern and being connected to the ground conductor, and the resonant conductor pattern is separated from the sub-ground conductor pattern with an insulating gap provided therebetween, and is connected to the sub-ground conductor pattern at least in one side of the resonant conductor pattern.

(9) In the common mode filter according to Item (1), the resonant conductor pattern is formed in the same layer as the ground conductor, is separated from the ground conductor with an insulating gap provided therebetween, and is connected to the ground conductor at least in one side of the resonant conductor pattern.

(10) In the common mode filter according to Item (1), the number of connection portions between the cover conductor pattern and the ground conductor is larger than the number of connection portions between the resonant conductor pattern and the ground conductor.

(11) In the common mode filter according to any one of Items (1) to (10), each of the pair of differential signal lines has one end connected through a via to a surface mounting terminal formed on a front surface layer of the multilayer substrate, and another end connected through a via to an external connection terminal formed on at least one of the front surface layer or a back surface layer of the multilayer substrate.

(12) In the common mode filter according to Item (11), a length obtained by adding, to a distance in plan view between the via connecting each of the pair of differential signal lines and the surface mounting terminal to each other and a connection position between the resonant conductor pattern and the ground conductor, a distance in side view between each of the pair of differential signal lines and the surface mounting terminal is shorter than ⅜ of a resonant wavelength of the resonant conductor pattern.

(13) There is provided an optical transceiver including: the common mode filter of Item (11); a signal processing circuit mounted on the multilayer substrate via the surface mounting terminal; a photoelectric conversion circuit which is mounted on the multilayer substrate, and is connected to the signal processing circuit; and an optical fiber connector optically connected to the photoelectric conversion circuit.

(14) There is provided an optical transceiver including: the common mode filter of Item (12); a signal processing circuit mounted on the multilayer substrate via the surface mounting terminal; a photoelectric conversion circuit which is mounted on the multilayer substrate, and is connected to the signal processing circuit; and an optical fiber connector optically connected to the photoelectric conversion circuit.

### BRIEF DESCRIPTION OF THE DRAWINGS

FIG. 1 is a schematic plan view of a filter forming section in which a common mode filter according to a first embodiment of the present invention is formed.

FIG. 2 is a cross-sectional view taken along the line II-II of FIG. 1.

FIG. 3 is a cross-sectional view taken along the line III-III of FIG. 1.

FIG. 4 is a graph for showing frequency characteristics of common mode filters created based on three different design conditions.

FIG. 5 is a schematic plan view of a filter forming section in which a common mode filter according to a second embodiment of the present invention is formed.

FIG. 6 is a cross-sectional view taken along the line VI-VI of FIG. 5.

FIG. 7 is a cross-sectional view taken along the line VII-VII of FIG. 5.

FIG. 8 is a schematic plan view of a filter forming section in which a common mode filter according to a third embodiment of the present invention is formed.

FIG. 9 is a cross-sectional view taken along the line IX-IX of FIG. 8.

FIG. 10 is a cross-sectional view taken along the line X-X of FIG. 8.

FIG. 11 is a schematic plan view of a filter forming section in which a common mode filter according to a fourth embodiment of the present invention is formed.

FIG. 12 is a cross-sectional view taken along the line XII-XII of FIG. 11.

FIG. 13 is a cross-sectional view taken along the line XIII-XIII of FIG. 11.

FIG. 14 is a schematic plan view of a filter forming section in which a common mode filter according to a fifth embodiment of the present invention is formed.

FIG. 15 is a cross-sectional view taken along the line XV-XV of FIG. 14.

FIG. 16 is a cross-sectional view taken along the line XVI-XVI of FIG. 14.

FIG. 17 is a schematic plan view of a filter forming section in which a common mode filter according to a sixth embodiment of the present invention is formed.

FIG. 18 is a cross-sectional view taken along the line XVIII-XVIII of FIG. 17.

FIG. 19 is a cross-sectional view taken along the line XIX-XIX of FIG. 17.

FIG. 20 is a schematic plan view of a filter forming section in which a common mode filter according to a seventh embodiment of the present invention is formed.

FIG. 21 is a cross-sectional view taken along the line XXI-XXI of FIG. 20.

FIG. 22 is a cross-sectional view taken along the line XXII-XXII of FIG. 20.

FIG. 23 is a schematic plan view of a filter forming section in which a common mode filter according to an eighth embodiment of the present invention is formed.

FIG. 24 is a cross-sectional view taken along the line XXIV-XXIV of FIG. 23.

FIG. 25 is an exterior view of an optical transceiver according to a ninth embodiment of the present invention.

FIG. 26 is a schematic view for illustrating an internal structure of the optical transceiver.

### DETAILED DESCRIPTION OF THE INVENTION

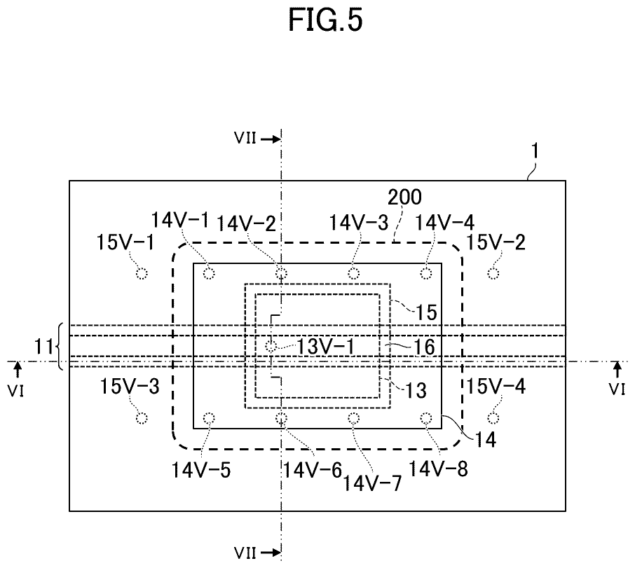

According to the applicant's findings, the common mode filter created in the differential transmission line as described in JP 2012-227887 A has a high common mode suppression effect. It can be read from the analysis results of the differential transmission line shown in FIG. 5 of JP 2012-227887 A that the common mode is suppressed in a large width of 10 GHz or more with respect to the frequency of 20.5 GHz serving as a center, and, at the center frequency, a suppression ratio of about −35 dB is achieved.

Having a wide bandwidth in which the common mode suppression effect is exerted and having a high suppression ratio as described above are not always advantages as the common mode filter. For example, a signal processing circuit in an optical communication module as described in JP 2012-227887 A is ideally designed for the purpose of outputting only a differential mode signal, and, in most cases, the common mode noise is intrinsically smaller than the differential mode signal.

Accordingly, the signal suppression ratio of the common mode desired for the common mode filter is generally only required to be from about 3 dB to about 5 dB.

Further, in paragraph 0056 of JP 2012-227887 A, there is described a warning to avoid setting a planar distance from a connection pad of the signal processing circuit to a via hole connected to a resonator of the common mode filter to become the vicinity of an integer multiple of ½ of the resonant wavelength. The reason therefor is because, as also described in JP 2012-227887 A, a loop path in which the common mode component whose transmission is suppressed passes through a ground conductor to return to the signal processing circuit is formed, and hence, when the length of the loop path is identical with the vicinity of the integer multiple of the propagation wavelength, this loop path functions as a loop antenna to radiate the suppressed common mode component as a radiation noise.

This fact means that, as the bandwidth in which the suppression effect obtained by the common mode filter is exerted becomes wider, a geometric condition under which this loop path functions as a loop antenna becomes wider, and thus the design flexibility at the time of designing the differential transmission line becomes lower.

The applicant has made the present invention in view of such circumstances. The present invention may provide an optical transceiver in which, when a common mode filter achieved by a print pattern created in a multilayer substrate is used in a differential transmission line, a suppression bandwidth and a suppression ratio of a common mode are reduced from those in the related art, thereby enhancing the design flexibility of the differential transmission line and downsizing the optical transceiver.

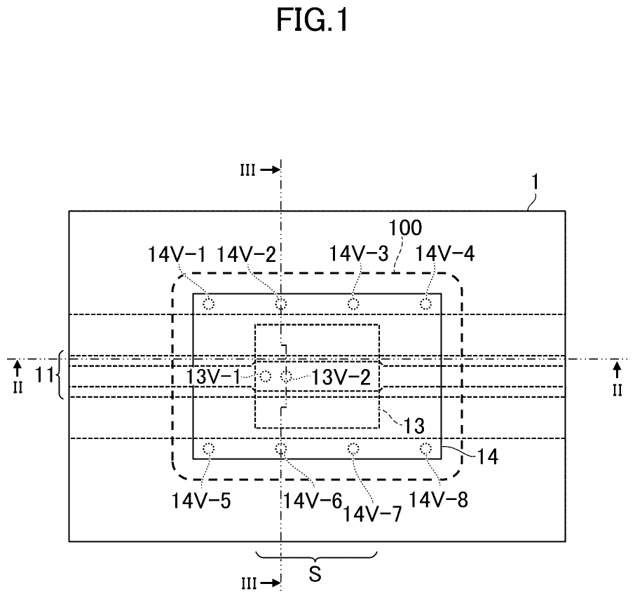

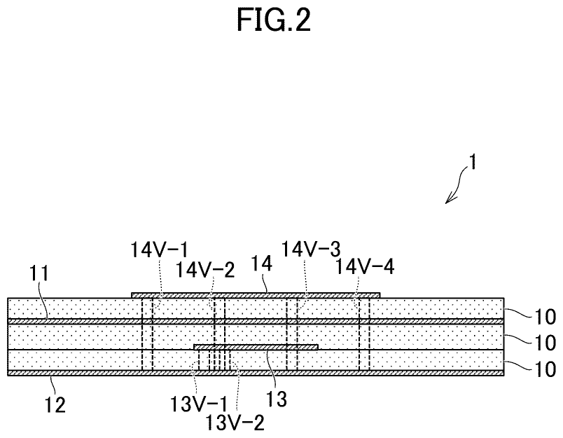

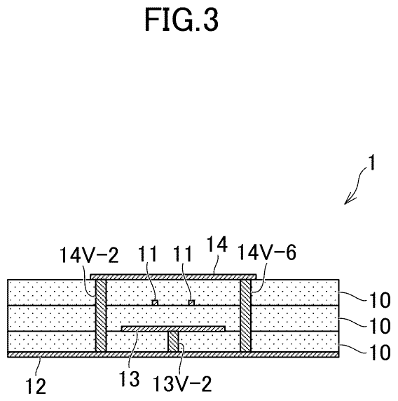

FIG. 1 is a schematic plan view of a filter forming section 1 in which a common mode filter 100 according to a first embodiment of the present invention is formed. FIG. 2 is a cross-sectional view taken along the line II-II of FIG. 1. FIG. 3 is a cross-sectional view taken along the line III-III of FIG. 1.

The filter forming section 1 is formed of some layers in a multilayer substrate which is a dielectric multilayer printed circuit board, and each of the layers of the multilayer substrate normally has a metal conductor pattern of copper, aluminum, or the like formed thereon. A layer exposed at a front surface of the multilayer substrate is herein referred to as “front surface layer,” and a layer exposed at a back surface thereof is herein referred to as “back surface layer.” Further, a layer of the filter forming section 1 closest to the front surface layer is referred to as “zeroth layer,” a layer on the lower side thereof is referred to as “first layer,” a layer further on the lower side thereof is referred to as “second layer,” and so on. The total number of layers of the filter forming section 1 is three at least and five or more at most as disclosed in a plurality of embodiments in the following. Thus, the front surface layer of the multilayer substrate and the zeroth layer of the filter forming section 1 do not always indicate the same layer. Further, similarly, the back surface layer of the multilayer substrate does not always indicate the lowermost layer of the filter forming section 1. A dielectric layer 10 made of a glass epoxy material, a ceramic material, a PPE material, a Teflon (trademark) material, or the like is arranged between each of adjacent layers of the multilayer substrate including the filter forming section 1, and connection between the conductor patterns of the respective layers is achieved by a via provided as appropriate.

As is clear from FIG. 2 and FIG. 3, the filter forming section 1 in the first embodiment is illustrated to have four layers, but the filter forming section 1 may have five or more layers. Further, the filter forming section 1 is illustrated in FIG. 1 to have a rectangular outer shape, but this outer shape represents only a part cut into a rectangular shape required for the sake of the following description. The filter forming section 1 may have a shape further extended to the outer side, and its outer shape may be freely selected as well. The same holds true also in other embodiments in the following.

In addition, in the filter forming section 1, a pair of differential signal lines 11 and the common mode filter 100 on transmission paths of the differential signal lines 11 are formed of a conductor pattern. FIG. 1 shows a region in which the common mode filter is formed by the thick broken line.

The differential signal lines 11 are formed in the first layer, and are arranged in parallel to each other in a right-left direction of FIG. 1. Further, in the third layer, a ground conductor 12 is formed as a solid pattern, and is connected to a ground potential outside of the figure. The ground conductor 12 is formed in a layer below the differential signal lines 11, but the layer is not always required to be the back surface layer. The fourth layer, the fifth layer, . . . may further be present.

In the second layer which is a layer below the differential signal lines 11 and above the ground conductor 12, a resonant conductor pattern 13 is provided. The resonant conductor pattern 13 covers partial regions of the differential signal lines 11 in plan view, that is, in projection of FIG. 1, and is connected to the ground conductor 12 through two vias 13V-1 and 13V-2. In this example, the resonant conductor pattern 13 has a rectangular shape, and the vias 13V-1 and 13V-2 are provided at positions which are on an intermediate line of the pair of differential signal lines 11 and deviated to one side of the resonant conductor pattern 13, in the example of FIG. 1, to the left side of the resonant conductor pattern 13.

Moreover, in the zeroth layer which is a layer above the differential signal lines 11, a cover conductor pattern 14 is provided. The cover conductor pattern 14 covers the resonant conductor pattern 13 in plan view, and is connected to the ground conductor 12 through eight vias 14V-1 to 14V-8. In this example, the cover conductor pattern 14 has a rectangular shape, and the vias 14V-1 to 14V-8 are equally provided at a peripheral edge portion of the cover conductor pattern 14.

Here, the phrase “A covers B” in plan view as used herein means that A overlaps not only the region of B but also an outer region adjacent to B. Thus, the resonant conductor pattern 13 overlaps not only the partial regions of the differential signal lines 11, but also a region sandwiched between the differential signal lines 11 and regions on outer sides of and adjacent in an up-down direction to the differential signal lines 11 illustrated in FIG. 1, which are adjacent to the partial regions. Further, the cover conductor pattern 14 also overlaps an outer region adjacent to the four sides of the resonant conductor pattern 13. In the first embodiment, the cover conductor pattern 14 is shown to be narrower than the ground conductor 12, but, in an actual case, the cover conductor pattern 14 may be wider than the ground conductor 12. Moreover, as viewed in the schematic plan view of FIG. 1, the cover conductor pattern 14 may cover not only parts but the entirety of the differential signal lines 11. Further, in the cross-sectional views of FIG. 2 and FIG. 3 in the first embodiment, the cover conductor pattern 14 is illustrated as the front surface layer, but the cover conductor pattern 14 is not always required to be the front surface layer. A dielectric layer may be further provided above the cover conductor pattern 14, and another layer (not shown) may further be provided. The same holds true also in other embodiments described in the following.

When the specific dimensions and shapes of the resonant conductor pattern 13, the positions and numbers of the vias 13V-1 and 13V-2, and the material and thickness of the dielectric layer are changed, a filter characteristic such as a resonant frequency of the common mode filter 100 can be adjusted in accordance with a usage condition of the differential signal lines 11. The filter characteristic can be measured by actually creating the filter forming section 1 having the common mode filter 100 formed therein and measuring the characteristic thereof. In addition, a high frequency simulator can be used to simulate and estimate the filter characteristic on a computer to make use for specific design.

Further, in a region S in which the differential signal lines 11 overlap the resonant conductor pattern 13, line widths of the differential signal lines 11 are narrowed. The reason therefor is as follows. In the region S, the differential signal lines 11 and the resonant conductor pattern 13 come close to each other, and thus the characteristic impedance in the region S becomes different from those in regions on front and rear sides of the region S to cause signal reflection or the like. The line width is narrowed so as to prevent this signal reflection or the like from occurring, and thus there is no change or a small change in characteristic impedance between the region S and regions on front and rear sides of the region S. The narrowing of the differential signal lines 11 is not always essential, and may be carried out as required. In the following embodiments, for the sake of easier description, no reference is made to the narrowing of the differential signal lines 11, but needless to say, the narrowing may be carried out.

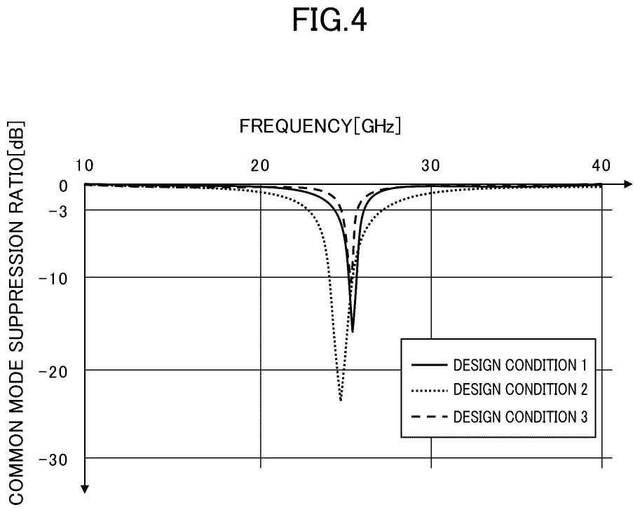

Results obtained by calculating, by the high frequency simulator, the filter characteristic of the common mode filter 100 having the configuration of the above-mentioned first embodiment are shown in FIG. 4. FIG. 4 shows the frequency characteristics of the common mode filters 100 created based on three different design conditions, and the characteristic impedances of the differential signal lines 11 are all about 100 ohms. The design conditions are as shown in the following table.

TABLE 1

| | Design | Design | Design |
|---|---|---|---|
| | condition 1 | condition 2 | condition 3 |
| Dielectric layer | 0.143 mm | 0.143 mm | 0.054 mm |
| thickness (between | | | |
| zeroth layer and | | | |
| first layer) | | | |
| Dielectric layer | 0.143 mm | 0.054 mm | 0.143 mm |
| thickness (between | | | |
| first layer and | | | |
| second layer) | | | |
| Differential signal | 0.12 mm | 0.076 mm | 0.076 mm |
| line width | | | |
| Distance between | 0.15 mm | 0.248 mm | 0.248 mm |
| differential signal | | | |
| lines | | | |
| Dielectric layer | 0.18 mm | 0.22 mm | 0.22 mm |
| thickness (between | | | |
| first layer and | | | |
| fourth layer) | | | |

As is understood from FIG. 4, in the design condition 1, a suppression width in which the common mode suppression ratio becomes −3 dB or less is about 1.7 GHz, and a peak suppression ratio at the center frequency is −16 dB. In the design condition 2, the suppression width is about 4.1 GHz, and the peak suppression ratio is −24 dB. In the design condition 3, the suppression width is about 0.8 GHz, and the peak suppression ratio is −10.4 dB.

As described above, in the common mode filter 100 according to the first embodiment, as compared to a common mode filter that has already been given as the related art, the suppression bandwidth is narrowed, and the suppression ratio is reduced. Thus, it is clear that the common mode filter 100 contributes to enhancing the design flexibility of the differential transmission lines and downsizing a device using this common mode filter 100. Further, when the design condition is changed, the suppression bandwidth, the suppression ratio, and the center frequency of the common mode filter 100 can be adjusted to some extent, and it can be understood that the common mode filter 100 can be designed in accordance with various usage conditions of the differential signal lines 11.

Further, in the first embodiment, the number of connection portions between the cover conductor pattern 14 and the ground conductor 12 is eight corresponding to the vias 14V-1 to 14V-8. Meanwhile, the number of connection portions between the resonant conductor pattern 13 and the ground conductor 12 is two corresponding to the vias 13V-1 and 13V-2. Thus, the number of the connection portions between the cover conductor pattern 14 and the ground conductor 12 is larger. The reason therefor is because of the difference between the resonant conductor pattern 13 having the main purpose to achieve a function as the common mode filter 100 by creating an electric oscillation inside of the resonant conductor pattern 13 and the cover conductor pattern 14 having the main purpose to keep a ground potential as uniform as possible with the ground conductor 12. In this meaning, the cover conductor pattern 14 and the ground conductor 12 are normally connected to each other through more than two vias, and, as a matter of course, the number of vias may be larger than the illustrated case of eight. With this structure, a desired characteristic of the common mode filter 100 can be obtained.

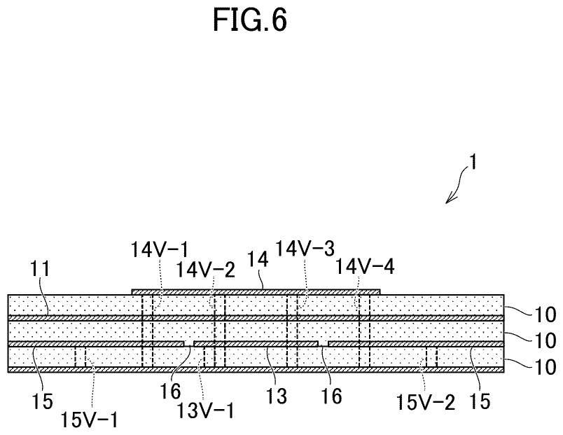

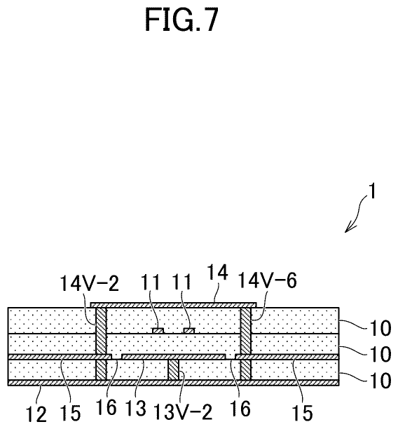

FIG. 5 is a schematic plan view of a filter forming section 1 in which a common mode filter 200 according to a second embodiment of the present invention is formed. FIG. 6 is a cross-sectional view taken along the line VI-VI of FIG. 5. FIG. 7 is a cross-sectional view taken along the line VII-VII of FIG. 5. For description of the illustrated common mode filter 200, components common to the above-mentioned embodiment are denoted by the same reference symbols, and the previous description is applied to support a redundant description thereof.

In the second embodiment as well, similarly to the above-mentioned embodiment, the filter forming section 1 includes four layers including: the first layer in which the differential signal line 11 are provided; the third layer in which the ground conductor 12 is provided; the second layer which is a layer below the differential signal lines 11 and above the ground conductor 12, and in which the rectangular resonant conductor pattern 13 is provided; and the zeroth layer in which the rectangular cover conductor pattern 14 is provided. Similarly to the first embodiment, in plan view, the resonant conductor pattern 13 covers partial regions of the differential signal lines 11, and the cover conductor pattern 14 covers the resonant conductor pattern 13. Further, the resonant conductor pattern 13 is connected to the ground conductor 12 through the via 13V-1, and the cover conductor pattern 14 is connected to the ground conductor 12 through the eight vias 14V-1 to 14V-8. Similarly to the above-mentioned embodiment, the number of vias for connecting the cover conductor pattern 14 and the ground conductor 12 to each other is not limited to eight and is merely an example. In general, the ground potential of the cover conductor pattern 14 becomes more stable when a larger number of vias are used, and hence the number of vias for connecting the cover conductor pattern 14 and the ground conductor 12 to each other may be selected to be a number that is sufficient for making the ground potential of the cover conductor pattern 14 stable. The number may be smaller or larger than eight. The same holds true in the embodiments described in the following.

The common mode filter 200 further includes, in the second layer which is the same layer as the resonant conductor pattern 13, a sub-ground conductor pattern 15 which surrounds the resonant conductor pattern 13 in plan view, and is connected to the ground conductor 12. The resonant conductor pattern 13 and the sub-ground conductor pattern 15 are separated from each other with an insulating gap 16 provided therebetween, and are isolated from each other within the second layer being the same layer.

The sub-ground conductor pattern 15 is also electrically connected to the vias 14V-1 to 14V-8, and hence is kept to the same potential (that is, the ground potential) as the ground conductor 12 through those vias 14V-1 to 14V-8. Moreover, vias 15V-1 to 15V-4 are provided so that the number of connection portions to the ground conductor 12 is increased. In the illustrated example, the number of the additional vias 15V-1 to 15V-4 is four, but the number of the additional vias and the arrangement thereof may be freely selected.

Even with the common mode filter 200 having such a structure, the desired characteristic of the common mode filter 200 can be obtained similarly to the above-mentioned embodiment.

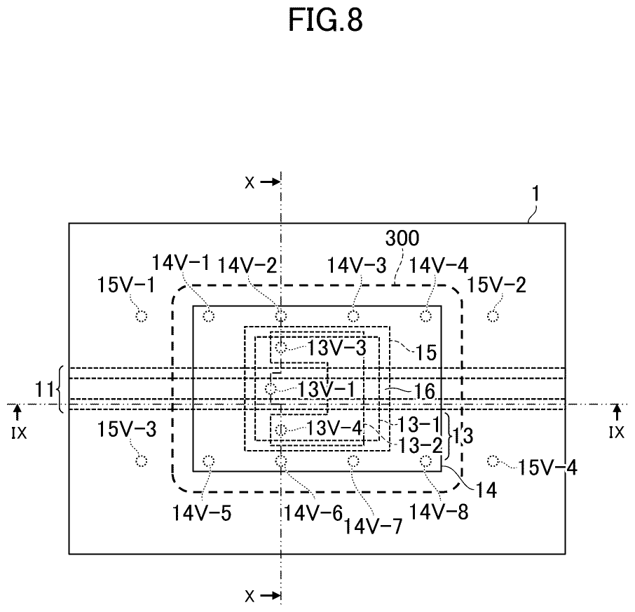

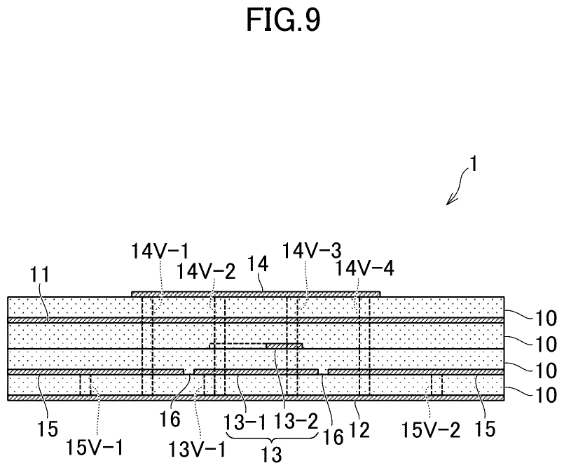

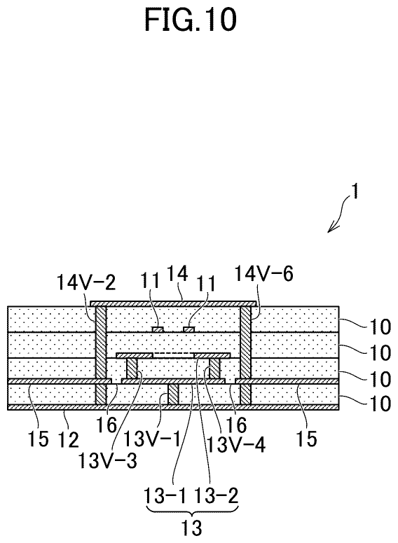

FIG. 8 is a schematic plan view of a filter forming section 1 in which a common mode filter 300 according to a third embodiment of the present invention is formed. FIG. 9 is a cross-sectional view taken along the line IX-IX of FIG. 8. FIG. 10 is a cross-sectional view taken along the line X-X of FIG. 8. For description of the illustrated common mode filter 300, components common to the above-mentioned embodiments are denoted by the same reference symbols, and the previous description is applied to support a redundant description thereof.

In the third embodiment, the filter forming section 1 includes five layers including: the first layer in which the differential signal lines 11 are provided; the fourth layer in which the ground conductor 12 is provided; and the third layer and the second layer which are layers below the differential signal lines 11 and above the ground conductor 12, and in which a first resonant conductor pattern 13-1 and a second resonant conductor pattern 13-2 which form the resonant conductor pattern 13 are provided, respectively. Further, in the zeroth layer, the rectangular cover conductor pattern 14 is provided. In plan view, each of the first resonant conductor pattern 13-1 and the second resonant conductor pattern 13-2 covers partial regions of the differential signal lines 11, and the cover conductor pattern 14 covers the resonant conductor pattern 13, that is, covers both of the first resonant conductor pattern 13-1 and the second resonant conductor pattern 13-2. Similarly to the above-mentioned embodiments, the cover conductor pattern 14 is connected to the ground conductor through the eight vias 14V-1 to 14V-8. Further, in the third layer that is the same layer as the first resonant conductor pattern 13-1, the sub-ground conductor pattern 15 which surrounds the first resonant conductor pattern 13-1 in plan view, and is connected to the ground conductor 12 is provided. The first resonant conductor pattern 13-1 and the sub-ground conductor pattern 15 are separated from each other with the insulating gap 16 provided therebetween, and are isolated from each other in the third layer being the same layer. Moreover, the sub-ground conductor pattern 15 is not only electrically connected to the vias 14V-1 to 14V-8, but also connected to the ground conductor 12 through the additional vias 15V-1 to 15V-4.

In the common mode filter 300 according to the third embodiment, the resonant conductor pattern 13 is formed of the first resonant conductor pattern 13-1 and the second resonant conductor pattern 13-2. The first resonant conductor pattern 13-1 formed in the third layer has a rectangular shape, and is connected to the ground conductor 12 through the via 13V-1. Moreover, the second resonant conductor pattern 13-2 in a layer above the first resonant conductor pattern 13-1 has a U-shape in plan view, and is connected to the first resonant conductor pattern 13-1 through vias 13V-3 and 13V-4.

Here, the first resonant conductor pattern 13-1 and the second resonant conductor pattern 13-2 are different from each other in geometric shapes, and are thus considered to be different from each other also in resonant frequencies and filter characteristics with respect to the common mode. Thus, when the resonant conductor pattern 13 is formed of a plurality of patterns that are different from each other in geometric shapes, as compared to a case in which the resonant conductor pattern 13 is formed of a single pattern, the common mode filter characteristic can be more flexibly designed. For example, the common mode filter 300 that functions for a plurality of resonant frequencies can be designed.

Further, in the third embodiment, in plan view, the first resonant conductor pattern 13-1 and the second resonant conductor pattern 13-2 are arranged so that parts thereof overlap each other. As described above, one pattern included in the plurality of patterns forming the resonant conductor pattern 13, for example, the first resonant conductor pattern 13-1, and another pattern, for example, the second resonant conductor pattern 13-2, are formed in layers different from each other, and are arranged so that at least parts thereof overlap each other in plan view. In this manner, an area to be occupied by the common mode filter 300 in plan view can be reduced, and the common mode filter 300 can be downsized.

Even with the common mode filter 300 having such a structure, the desired characteristic of the common mode filter 300 can be obtained similarly to the above-mentioned embodiments.

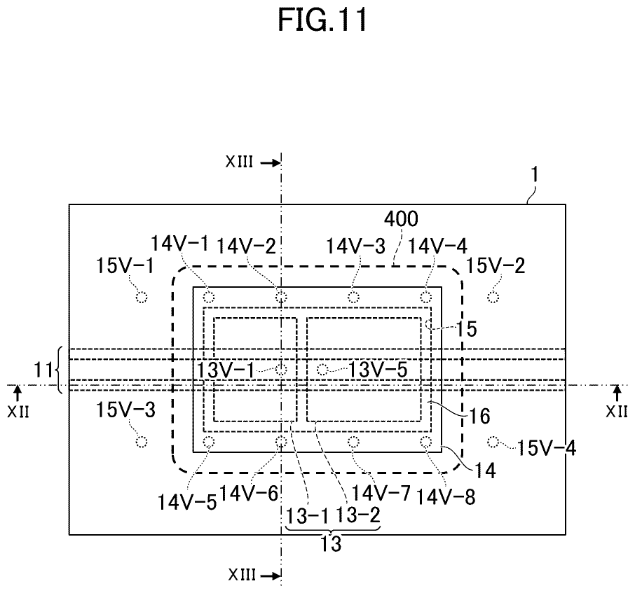

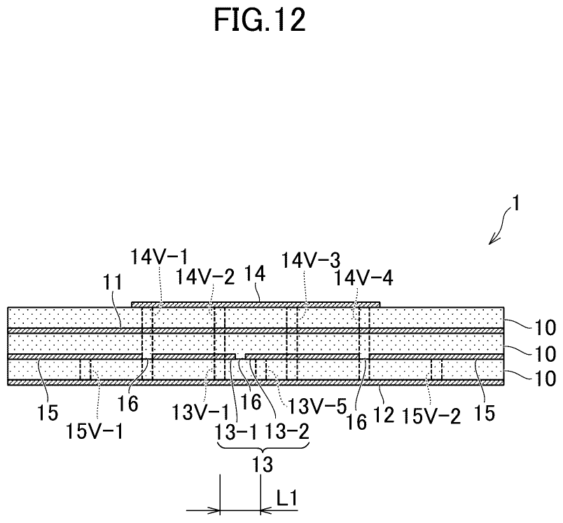

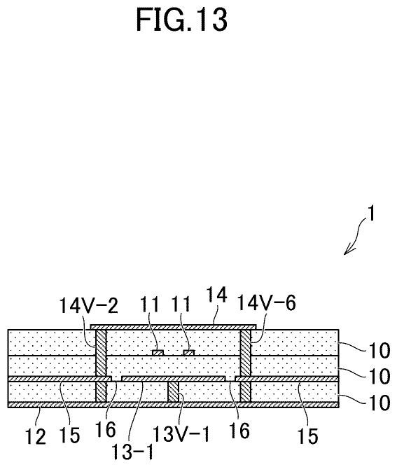

FIG. 11 is a schematic plan view of a filter forming section 1 in which a common mode filter 400 according to a fourth embodiment of the present invention is formed. FIG. 12 is a cross-sectional view taken along the line XII-XII of FIG. 11. FIG. 13 is a cross-sectional view taken along the line XIII-XIII of FIG. 11. For description of the illustrated common mode filter 400, components common to the above-mentioned embodiments are denoted by the same reference symbols, and the previous description is applied to support a redundant description thereof.

In the fourth embodiment, the filter forming section 1 includes four layers including: the first layer in which the differential signal lines 11 are provided; the third layer in which the ground conductor 12 is provided; and the second layer which is a layer below the differential signal lines 11 and above the ground conductor 12, and in which a first resonant conductor pattern 13-1 and a second resonant conductor pattern 13-2 which form the resonant conductor pattern 13 are provided. Further, in the zeroth layer, the rectangular cover conductor pattern 14 is provided. In plan view, each of the first resonant conductor pattern 13-1 and the second resonant conductor pattern 13-2 covers partial regions of the differential signal lines 11, and the cover conductor pattern 14 covers the resonant conductor pattern 13, that is, covers both of the first resonant conductor pattern 13-1 and the second resonant conductor pattern 13-2. Similarly to the above-mentioned embodiments, the cover conductor pattern 14 is connected to the ground conductor 12 through the eight vias 14V-1 to 14V-8. Further, in the second layer that is the same layer as the first resonant conductor pattern 13, the sub-ground conductor pattern 15 which surrounds the first resonant conductor pattern 13-1 and the second resonant conductor pattern 13-2 in plan view, and is connected to the ground conductor 12 is provided. Each of the first resonant conductor pattern 13-1, the second resonant conductor pattern 13-2, and the sub-ground conductor pattern 15 are separated from each other with the insulating gap 16 provided therebetween, and are isolated from each other in the second layer being the same layer. Moreover, the sub-ground conductor pattern 15 is not only electrically connected to the vias 14V-1 to 14V-8, but also connected to the ground conductor 12 through the additional vias 15V-1 to 15V-4.

Here, the first resonant conductor pattern 13-1 and the second resonant conductor pattern 13-2 are different from each other in geometric shapes or connection positions relative to the ground conductor 12, or in both thereof. In the example illustrated in FIG. 11, the dimensions of the first resonant conductor pattern 13-1 are smaller than the dimensions of the second resonant conductor pattern 13-2. Instead, the first resonant conductor pattern 13-1 and the second resonant conductor pattern 13-2 may have the same geometric shape, and may be different in connection positions relative to the ground conductor 12, that is, positions of the vias 13V-1 and 13V-5 within the patterns. In this manner, the first resonant conductor pattern 13-1 and the second resonant conductor pattern 13-2 can have filter characteristics different from each other.

Even with the common mode filter 400 having such a structure, similarly to the above-mentioned embodiments, the common mode filter characteristic can be more flexibly designed, and the number of layers of the filter forming section 1 can be reduced to be smaller than that of the common mode filter 300 according to the above-mentioned embodiment.

It is preferred that a distance L1 between centers of the vias 13V-1 and 13V-5 illustrated in FIG. 12 be as short as possible, and both of the vias 13V-1 and 13V-5 be close to each other. In other words, it is preferred that a distance in plan view between a connection position between the first resonant conductor pattern 13-1 and the ground conductor 12 and a connection position between the second resonant conductor pattern 13-2 and the ground conductor 12 be shorter. The reason therefor is because the short distance prevents the common mode removed from the differential signal lines 11 from causing resonance between the first resonant conductor pattern 13-1 and the second resonant conductor pattern 13-2 to become a noise. More specifically, L1 is set to be shorter than ⅜ of the resonant wavelength of each of the first resonant conductor pattern 13-1 and the second resonant conductor pattern 13-2. The reason therefor is because, when L1 becomes close to a half wavelength of the resonant wavelength and an integer multiple thereof, resonance occurs to increase a radiation noise, and it is safer in terms of design when L1 is shorter than ⅜ of the resonant wavelength.

In the common mode filter 400 illustrated in the fourth embodiment, the resonant conductor pattern 13 is formed of two patterns, but the same thing can be said even when the resonant conductor pattern 13 is formed of three or more patterns. Thus, the patterns are designed so that, in any two of the plurality of patterns included in the resonant conductor pattern 13, a distance in plan view between a connection position to the ground conductor 12 in one pattern and a connection position to the ground conductor 12 in another pattern becomes shorter than ⅜ of the resonant wavelength of each of the two patterns. The resonant wavelength is a length obtained by the effective dielectric constant and the resonant frequency.

Further, it is preferred that the width of the insulating gap 16 in the extending direction of the differential signal lines 11 illustrated in FIG. 12 be as small as possible. The reason therefor is as follows. A distance to the ground conductor 12 of the differential signal line 11 at the position of the insulating gap 16 becomes longer than a distance to the sub-ground conductor pattern 15 or the resonant conductor pattern 13 in another part, and the characteristic impedance of the differential signal line 11 in this part is different. As a result, there is a fear of causing signal loss due to reflection or the like on the path. When the width of the insulating gap 16 is set to be sufficiently small, for example, when the width of the insulating gap 16 is set to about 500 μm or less in a case in which the operation frequency of the differential signal is from 10 GHz to 30 GHz, the influence of the variation of the characteristic impedance of the differential signal line 11 is little and ignorable.

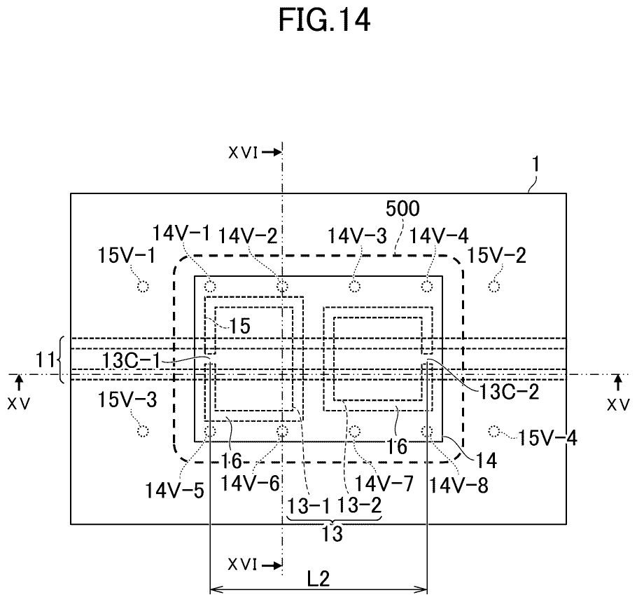

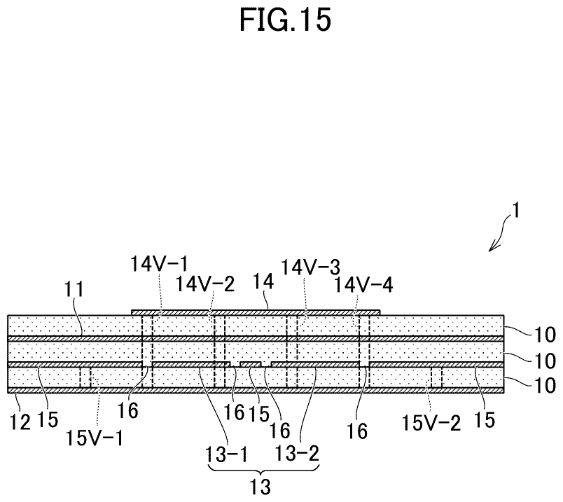

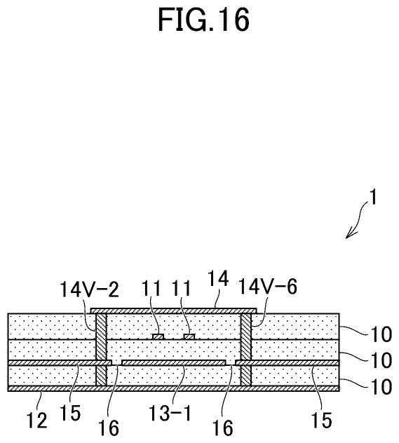

FIG. 14 is a schematic plan view of a filter forming section 1 in which a common mode filter 500 according to a fifth embodiment of the present invention is formed. FIG. 15 is a cross-sectional view taken along the line XV-XV of FIG. 14. FIG. 16 is a cross-sectional view taken along the line XVI-XVI of FIG. 14. For description of the illustrated common mode filter 500, components common to the above-mentioned embodiments are denoted by the same reference symbols, and the previous description is applied to support a redundant description thereof.

Also in the fifth embodiment, similarly to the above-mentioned embodiments, the filter forming section 1 includes four layers including: the first layer in which the differential signal lines 11 are provided; the third layer in which the ground conductor 12 is provided; and the second layer which is a layer below the differential signal lines 11 and above the ground conductor 12, and in which a first resonant conductor pattern 13-1 and a second resonant conductor pattern 13-2 which form the resonant conductor pattern 13 are provided. Further, in the zeroth layer, the rectangular cover conductor pattern 14 is provided. In plan view, each of the first resonant conductor pattern 13-1 and the second resonant conductor pattern 13-2 covers partial regions of the differential signal lines 11, and the cover conductor pattern 14 covers the resonant conductor pattern 13, that is, covers both of the first resonant conductor pattern 13-1 and the second resonant conductor pattern 13-2.

The cover conductor pattern 14 is connected to the ground conductor 12 through the eight vias 14V-1 to 14V-8. Further, in the second layer that is the same layer as the resonant conductor pattern 13, the sub-ground conductor pattern 15 which surrounds the first resonant conductor pattern 13-1 and the second resonant conductor pattern 13-2 in plan view, and is connected to the ground conductor 12 is provided. Moreover, the sub-ground conductor pattern 15 is not only electrically connected to the vias 14V-1 to 14V-8, but also connected to the ground conductor 12 through the additional vias 15V-1 to 15V-4.

In addition, each of the first resonant conductor pattern 13-1 and the second resonant conductor pattern 13-2 and the sub-ground conductor pattern 15 are separated from each other with the insulating gap 16 provided therebetween, but the connection to the ground conductor 12 is achieved by connecting to the sub-ground conductor pattern 15 in one side of each of the first resonant conductor pattern 13-1 and the second resonant conductor pattern 13-2, and no direct connection to the ground conductor 12 using the vias is achieved unlike the above-mentioned embodiments. In the example illustrated in FIG. 14, the first resonant conductor pattern 13-1 is connected to the sub-ground conductor pattern 15 by a connection portion 13C-1 on the left side of FIG. 14, and the second resonant conductor pattern 13-2 is connected to the sub-ground conductor pattern 15 by a connection portion 13C-2 on the right side of FIG. 14.

Also in this case, the first resonant conductor pattern 13-1 and the second resonant conductor pattern 13-2 are different from each other in geometric shapes or connection positions relative to the ground conductor 12, that is, arrangements of the connection portions 13C-1 and 13C-2 with respect to the first resonant conductor pattern 13-1 and the second resonant conductor pattern 13-2, and thus have filter characteristics different from each other. In the example shown here, one connection portion 13C-1 and one connection portion 13C-2 are provided for the first resonant conductor pattern 13-1 and the second resonant conductor pattern 13-2, respectively, but a plurality of connection portions 13C-1 and a plurality of connection portions 13C-2 may be provided, or the connection portions 13C-1 and 13C-2 may have different connection widths. When the plurality of connection portions are provided, those connection portions may be arranged in different sides. The connection portions 13C-1 and 13C-2 are specifically designed so that a desired filter characteristic can be obtained through an experiment or a simulation performed by a high frequency simulator. That is, the resonant conductor pattern 13 is connected to the sub-ground conductor pattern 15 at least in one side thereof.

Further, it is desired that a distance L2 in plan view between the connection portions 13C-1 and 13C-2 illustrated in FIG. 14 be shorter than ⅜ of the resonant wavelength of each of the first resonant conductor pattern 13-1 and the second resonant conductor pattern 13-2. The reason therefor is as described in the above-mentioned embodiment. Further, even when L2 exceeds ⅜ of the resonant wavelength, it is desired to design L2 so that L2 is prevented from becoming a length close to ½ of the resonant wavelength and an integer multiple thereof.

Even with the common mode filter 500 having such a structure, similarly to the above-mentioned embodiments, the common mode filter characteristic can be designed more flexibly, and the number of vias can be reduced as compared to that in the common mode filter 400 according to the above-mentioned embodiment.

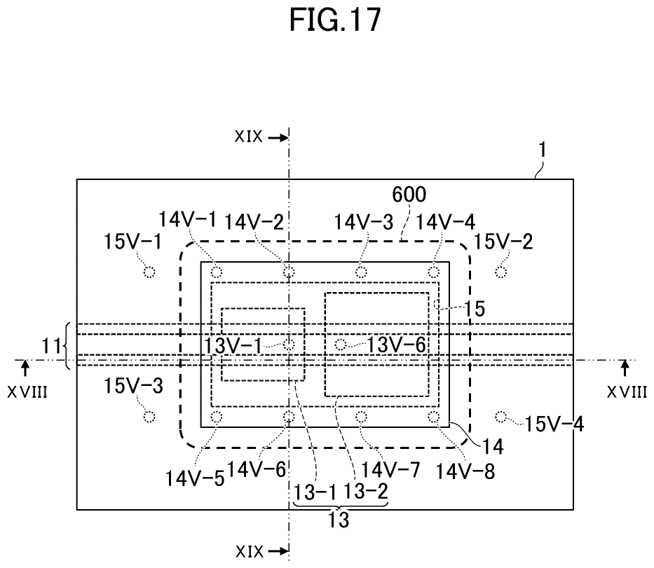

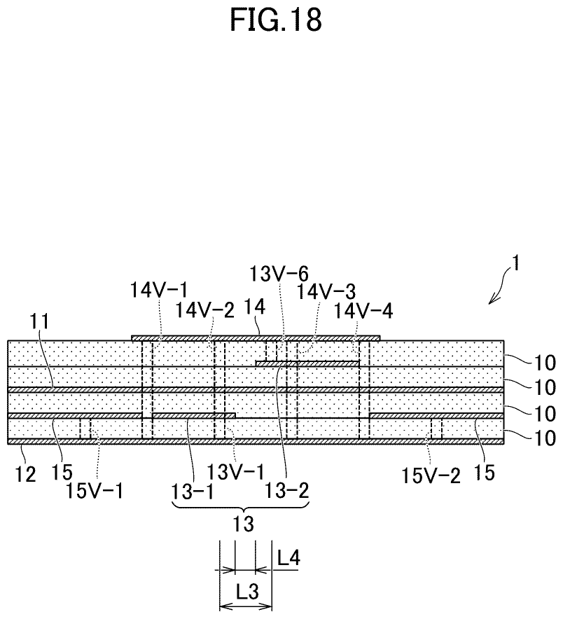

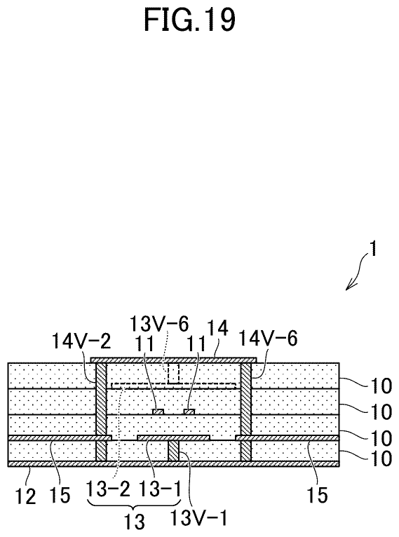

FIG. 17 is a schematic plan view of a filter forming section 1 in which a common mode filter 600 according to a sixth embodiment of the present invention is formed. FIG. 18 is a cross-sectional view taken along the line XVIII-XVIII of FIG. 17. FIG. 19 is a cross-sectional view taken along the line XIX-XIX of FIG. 17. For description of the illustrated common mode filter 600, components common to the above-mentioned embodiments are denoted by the same reference symbols, and the previous description is applied to support a redundant description thereof.

In the sixth embodiment, the filter forming section 1 includes five layers including: the second layer in which the differential signal lines 11 are provided; the fourth layer in which the ground conductor 12 is provided; the third layer in which the first resonant conductor pattern 13-1 forming the resonant conductor pattern 13 is provided; the first layer in which the second resonant conductor pattern 13-2 forming the resonant conductor pattern 13 is provided; and the zeroth layer in which the rectangular cover conductor pattern 14 is provided. In plan view, each of the first resonant conductor pattern 13-1 and the second resonant conductor pattern 13-2 covers partial regions of the differential signal lines 11, and the cover conductor pattern 14 covers the resonant conductor pattern 13, that is, covers both of the first resonant conductor pattern 13-1 and the second resonant conductor pattern 13-2. The cover conductor pattern 14 is connected to the ground conductor 12 through the eight vias 14V-1 to 14V-8. Further, in the third layer which is the same layer as the first resonant conductor pattern 13-1, the sub-ground conductor pattern 15 which surrounds the first resonant conductor pattern 13-1 and the second resonant conductor pattern 13-2 in plan view, and is connected to the ground conductor 12 is provided. That is, the sub-ground conductor pattern 15 is prevented from overlapping the resonant conductor pattern 13 in plan view. Moreover, the sub-ground conductor pattern 15 is not only electrically connected to the vias 14V-1 to 14V-8, but also connected to the ground conductor 12 through the additional vias 15V-1 to 15V-4.

As is clear from the figures, in the sixth embodiment, the first resonant conductor pattern 13-1 is formed in a layer below the differential signal lines 11, and the second resonant conductor pattern 13-2 is formed in a layer above the differential signal lines 11. In addition, the first resonant conductor pattern 13-1 is connected to the ground conductor 12 on the lower side through the via 13V-1, and the second resonant conductor pattern 13-2 is connected to the cover conductor pattern 14 on the upper side through a via 13V-6. In this manner, indirect connection to the ground conductor 12 is achieved.

This configuration can be adopted even when the resonant conductor pattern 13 is formed of a plurality of patterns, specifically, three or more patterns. That is, one pattern of the plurality of patterns is formed in a layer below the differential signal lines 11, and another pattern thereof is formed in a layer above the differential signal lines 11. Moreover, the one pattern is connected to the ground conductor 12 through a via, and the another pattern is connected to the cover conductor pattern 14 through a via.

Further, also in this case, the first resonant conductor pattern 13-1 and the second resonant conductor pattern 13-2 are different from each other in geometric shapes or connection positions relative to the ground conductor 12, that is, relative arrangements of the vias 13V-1 and 13V-6 with respect to the first resonant conductor pattern 13-1 and the second resonant conductor pattern 13-2, respectively, and thus have filter characteristics different from each other.

Further, it is desired that a distance L3 in plan view between the vias 13V-1 and 13V-6 illustrated in FIG. 18 be shorter than ⅜ of the resonant wavelength of each of the first resonant conductor pattern 13-1 and the second resonant conductor pattern 13-2. The reason therefor is as described in the above-mentioned embodiments. Moreover, it is preferred that a distance L4 in plan view between the first resonant conductor pattern 13-1 and the second resonant conductor pattern 13-2 also be as small as possible. The reason therefor is similar to that described in the fourth embodiment for the width of the insulating gap 16 in the extending direction of the differential signal lines 11, that is, for the purpose of reducing the influence of the change in characteristic impedance of the differential signal lines 11 in the section of L4. For example, when L4 is set to about 500 μm or less in a case in which the operation frequency of the differential signal is from 10 GHz to 30 GHz, the influence of the variation of the characteristic impedance of the differential signal line 11 is little and ignorable.

Even with the common mode filter 600 having such a structure, similarly to the above-mentioned embodiments, the common mode filter characteristic can be designed more flexibly.

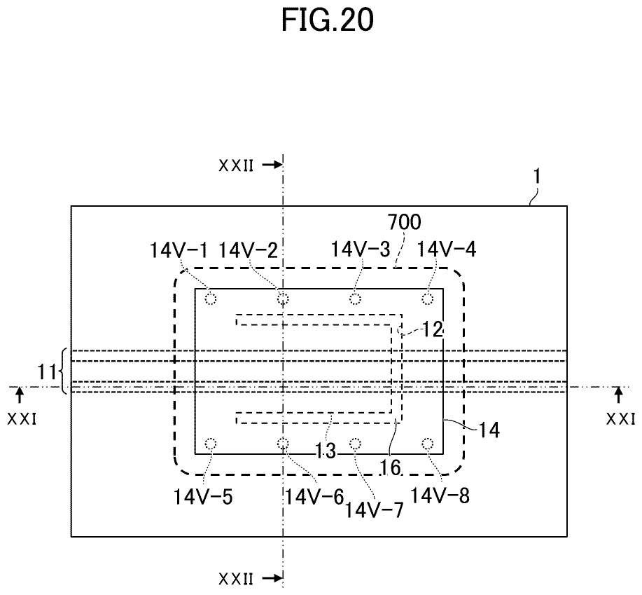

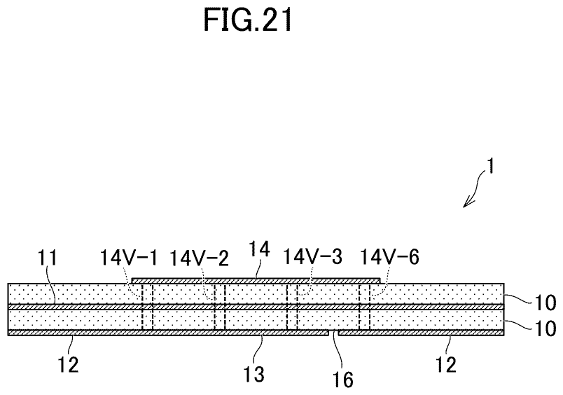

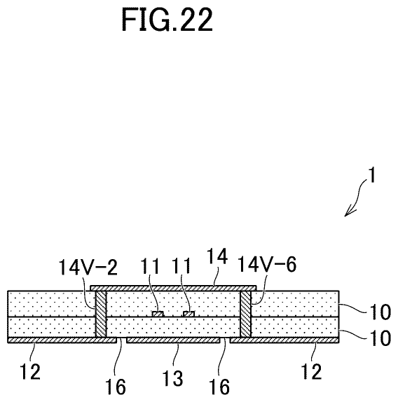

FIG. 20 is a schematic plan view of a filter forming section 1 in which a common mode filter 700 according to a seventh embodiment of the present invention is formed. FIG. 21 is a cross-sectional view taken along the line XXI-XXI of FIG. 20. FIG. 22 is a cross-sectional view taken along the line XXII-XXII of FIG. 20. For description of the illustrated common mode filter 700, components common to the above-mentioned embodiments are denoted by the same reference symbols, and the previous description is applied to support a redundant description thereof.

In the seventh embodiment, the filter forming section 1 includes three layers including: the first layer in which the differential signal lines 11 are provided; the second layer in which the ground conductor 12 is provided; and the zeroth layer in which the rectangular cover conductor pattern 14 is provided. The cover conductor pattern 14 is connected to the ground conductor 12 through the eight vias 14V-1 to 14V-8.

In addition, the resonant conductor pattern 13 is provided in the second layer which is the same layer as the ground conductor 12. That is, as illustrated in FIG. 20, the resonant conductor pattern 13 is separated from the ground conductor 12 with the insulating gap 16 provided therebetween, and is connected to the ground conductor 12 in at least one side, in this case, the left side thereof.

The resonant conductor pattern 13 shown here has a shape in which the entire left side thereof is coupled to the ground conductor 12 without being separated therefrom, but as in the first and second resonant conductor patterns 13-1 and 13-2 illustrated in FIG. 14 in the fifth embodiment, connection to the ground conductor 12 may be achieved by providing a connection portion in a part of the insulating gap 16. Further, the number of the connection portions and the arrangement thereof may be freely selected, and the resonant conductor pattern 13 is designed so as to provide a desired filter characteristic.

Even with the common mode filter 700 having such a structure, the desired characteristic of the common mode filter 700 can be obtained, and the structure of the common mode filter 700 can be simplified.

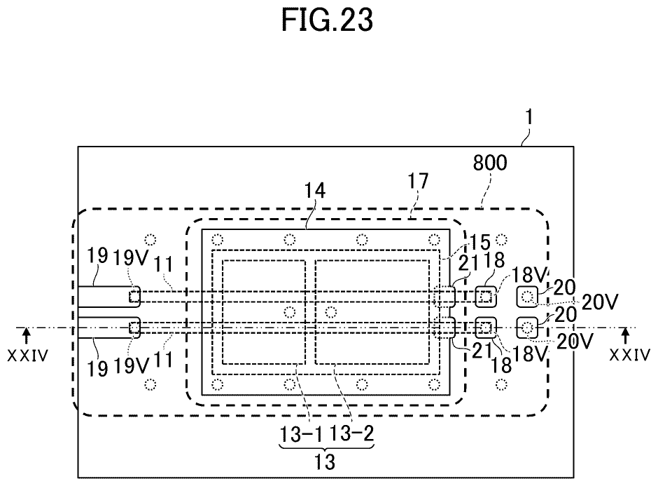

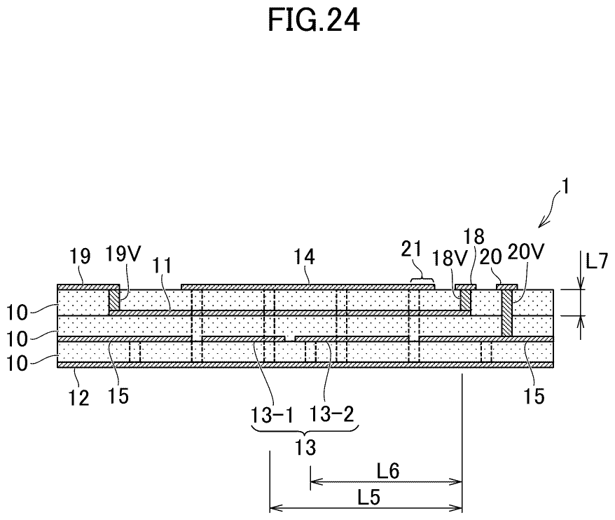

FIG. 23 is a schematic plan view of a filter forming section 1 in which a common mode filter 800 according to an eighth embodiment of the present invention is formed. FIG. 24 is a cross-sectional view taken along the line XXIV-XXIV of FIG. 23. For description of the illustrated common mode filter 800, components common to the above-mentioned embodiments are denoted by the same reference symbols, and the previous description is applied to support a redundant description thereof.

In the eighth embodiment, inside of a region of the common mode filter 800, a filter region 17 functioning as a filter for particularly suppressing the common mode of the differential signal lines 11 is provided. The filter region 17 corresponds to a region in which each of the common mode filters 100 to 700 according to the first to seventh embodiments described above is formed, and the configuration of this filter region 17 may be the configuration of any one of the first to seventh embodiments described above. In this case, the configuration of the common mode filter 400 according to the fourth embodiment is used, and hence description is given below with reference to this configuration.

In the eighth embodiment, similarly to the fourth embodiment, the filter forming section 1 includes four layers including: the first layer in which the differential signal lines 11 are provided; the third layer in which the ground conductor 12 is provided; the second layer in which the resonant conductor pattern 13 formed of the first resonant conductor pattern 13-1 and the second resonant conductor pattern 13-2 and the sub-ground conductor pattern 15 which surrounds the resonant conductor pattern 13 are provided; and the zeroth layer in which the rectangular cover conductor pattern 14 is provided. The connection structure between the ground conductor 12 and each of the cover conductor pattern 14, the resonant conductor pattern 13, and the sub-ground conductor pattern 15 is similar to that in the fourth embodiment, and hence description thereof is omitted here.

Here, the differential signal lines 11 are provided not on the front surface layer or the back surface layer, but in the inner layer of the multilayer substrate. Thus, when the side on which the signal processing circuit of the multilayer substrate is mounted is regarded as the front side and the side opposite thereto is regarded as the back side, in order to achieve connection to the signal processing circuit, it is required to achieve connection to a connection pad provided on the front surface layer of the multilayer substrate. Further, in order to achieve connection to an external device, it is required to achieve connection to a connection pad provided on the front surface layer or the back surface layer of the multilayer substrate or both of those layers, that is, at least one of the front surface layer or the back surface layer. Accordingly, one end of each of the differential signal lines 11, in FIG. 23, a right end portion of each of the differential signal lines 11 is connected to a surface mounting terminal 18 through a via 18V. Further, another end of each of the differential signal lines 11, in FIG. 23, a left end portion of each of the differential signal lines 11 is connected to an external connection terminal 19 through a via 19V. In the eighth embodiment, the external connection terminal 19 is illustrated as being provided on the front surface layer of the multilayer substrate, but this arrangement is merely an example, and a part or the whole of the external connection terminal 19 may be provided on the back surface layer of the multilayer substrate.

Further, in the vicinity of the surface mounting terminal 18, a ground terminal 20 is provided and connected to the sub-ground conductor pattern 15 through a via 20V. This via 20V may pass through the sub-ground conductor pattern 15 so as to be directly connected to the ground conductor 12.

Moreover, a surface mounting region 21 may be provided in a part of the cover conductor pattern 14. Those surface mounting terminal 18, ground terminal 20, and surface mounting region 21 form a so-called connection pad to be connected to a signal processing circuit when the signal processing circuit is mounted on the multilayer substrate. The geometric arrangement in plan view of the surface mounting terminal 18, the ground terminal 20, and the surface mounting region 21 is determined in accordance with connection terminal positions of the signal processing circuit to be mounted. The surface mounting terminal 18 is connected to a differential input/output terminal of the signal processing circuit, and the ground terminal 20 and the surface mounting region 21 are each connected to the ground terminal of the signal processing circuit.

Further, the external connection terminal 19 is a connection pad for achieving connection to the external device by, for example, wire bonding or a connector. Normally, the external connection terminal 19 is provided at an end portion of the multilayer substrate. Further, the length of each of the differential signal lines 11 connecting the external connection terminal 19 and the filter region 17 to each other may be freely designed.

In addition, when a distance in plan view between the via 18V which is a connection portion between the surface mounting terminal 18 and the differential signal line 11 and the via 13V-1 which is a connection portion between the resonant conductor pattern 13 and the ground conductor 12 is represented by L5, a distance in plan view between the via 18V and the via 13V-2 which is another connection portion between the resonant conductor pattern 13 and the ground conductor 12 is represented by L6, and a distance in side view between the surface mounting terminal 18 and the differential signal line 11 is represented by L7, it is desired that a length of L5+L7 and a length of L6+L7 be both designed to be shorter than ⅜ of the resonant wavelength of the resonant conductor pattern 13, or to avoid a length in the vicinity of an integer multiple of ½ of the resonant wavelength.

This design is made for the purpose of preventing, in the common mode removed from the differential signal lines 11, the electromagnetic waves reflected by the resonant conductor pattern 13 in the transmission line between the resonant conductor pattern 13 and the signal processing circuit from becoming a resonant noise to be radiated from the substrate. This situation is applied to, when the resonant conductor pattern 13 includes a plurality of patterns as described in the eighth embodiment, each of the patterns. Further, designing of the distance L5-L6 which is the distance between the via 13V-1 and the via 13V-2 so as to be shorter than ⅜ of the resonant wavelength of each of the first resonant conductor pattern 13-1 and the second resonant conductor pattern 13-2 is the same as that already described in the fourth embodiment.

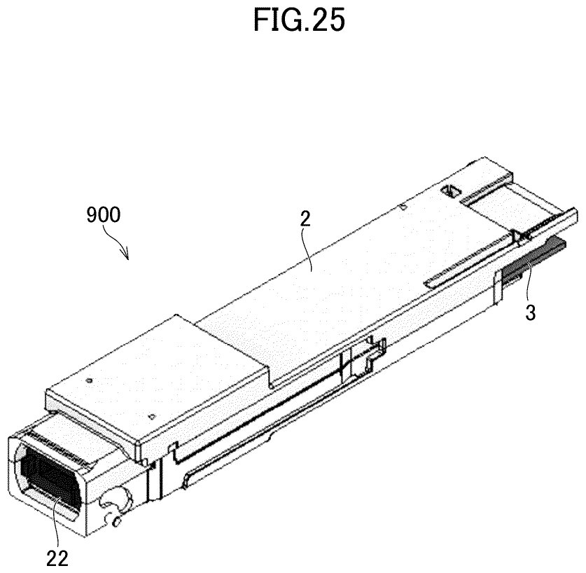

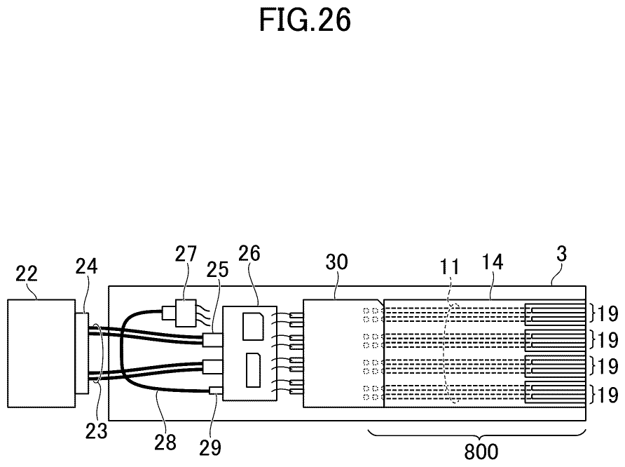

FIG. 25 is an exterior view of an optical transceiver 900 according to a ninth embodiment of the present invention. FIG. 26 is a schematic view for illustrating an internal structure of the optical transceiver 900. The optical transceiver 900 illustrated in FIG. 25 is an optical conversion adapter for converting, in optical communication, an optical signal input or output through use of an optical fiber and an electrical differential signal processed in an electronic device. There can be seen, at one end of the optical transceiver 900, an optical fiber adapter 22 into which an optical fiber plug connected to an optical fiber cable is to be inserted, and, at another end, a part of a multilayer substrate 3 electrically connected to the electronic device. Components of the optical transceiver 900 other than the optical fiber adapter 22 and the multilayer substrate 3 are integrally stored in a case 2.

In general, in the optical transceiver 900 as shown here, the case 2 is made of a metal, and, on the surface of the multilayer substrate 3 extending and exposing from one end of the case 2, a signal pad, a GND pad, and various control and power supply pads are arranged. When this optical transceiver 900 is inserted into a connector provided in various devices such as a router and a network switch, the electric signal can be input or output. Examples of the optical transceiver 900 include form factors such as QSFP and OSFP.

FIG. 26 simply shows the configuration inside of the case 2. An optical connector 24 is mounted on one end of the optical fiber 23, and this optical connector 24 is mounted to the optical fiber adapter 22 so that the optical input/output signal can be exchanged with the optical fiber plug (not shown). In this example, the optical connector 24 includes four optical fibers 23 in total, which are two for transmission and input and two for output.

Another end of the optical fiber 23 is formed into an optical fiber block 25 which allows the optical fiber 23 to be bonded and fixed to an optical circuit board 26 accurately and stably. Further, the optical transceiver 900 includes a light source package 27. The light source package 27 may be a generally-used package in which a laser element is mounted in a CAN package or the like. An optical fiber 28 is provided for light output, and has one end connected to the light source package 27 and another end similarly being formed into an optical fiber block 29. Thus, the optical fiber 28 can be bonded and fixed to the optical circuit board 26 accurately and stably. A lead pin of the light source package 27 is electrically connected to the connection pad of the multilayer substrate 3 so that control of the generated current supplied to the laser element and temperature control can be performed.

The optical circuit board 26 performs conversion between the optical input/output signal and the electric signal. As a specific example of this configuration, the optical circuit board 26 has an optical waveguide, an electric line, and the like that are accurately patterned. At the time of optical output thereof, light is output from the light source package 27, and the light introduced to the optical circuit board 26 is guided to a patterned Mach-Zehnder modulator through the optical waveguide so that the light is modulated. The modulated light is output from the optical fiber adapter 22 as the optical output signal via the optical fiber block 25. Further, at the time of optical input thereof, an optical waveguide and a photo diode are patterned on the optical circuit board 26, and the light input via the optical fiber block 25 is guided to the photo diode through the optical waveguide so that the received optical signal is converted into an electric signal.

Pads are provided on the optical circuit board 26, and the signals are electrically continuous with the differential signal lines 11 and the ground conductor on the multilayer substrate 3 via wires. In addition to the signals, various controls, power supplies, and the like are also similarly electrically continuous with the pads on the multilayer substrate 3 through use of wires, but, for the sake of easier illustration, illustration thereof is omitted in FIG. 26.

Further, on the multilayer substrate 3, various digital electric elements (not shown) may be mounted so as to be responsible for various functions such as shaping and amplification of an electric signal to be transmitted or received. Those various digital electric elements may be elements that are generally called CDR, MUX, DEMUX, DSP, and the like.

Further, on the multilayer substrate 3, a signal processing circuit 30 is mounted, and the signal processing circuit 30 extracts the electric signal input to or output from the optical circuit board 26 as a differential signal, and further performs, conversion, shaping, and the like of signals for transmission. In addition, a right part of the signal processing circuit 30 of the multilayer substrate 3 of FIG. 26 is formed into the common mode filter 800 according to the eighth embodiment described above. Through use of the surface mounting terminal, the ground terminal, the surface mounting region, and the like already described above, the differential signal lines 11, the ground conductor, and the cover conductor pattern which are formed in the internal layers in or below the first layer of the multilayer substrate 3 are connected to the signal processing circuit 30.

Further, a right part of the common mode filter 800 is formed into an electric connector which is exposed from the case 2 of the optical transceiver 900, and the external connection terminal 19 formed on any one of the front surface layer or the back surface layer of the multilayer substrate 3 (in the illustrated example, the front surface layer) is formed into a differential signal pad for connection to the external device. Further, the cover conductor pattern 14 has a comb shape and extends up to a right end side in FIG. 26 of the multilayer substrate 3, thereby playing a role as the GND pad. In plan view, the cover conductor pattern 14 covers the differential signal lines 11 passing through the internal layer of the multilayer substrate 3. Four pairs of differential signal lines 11 are illustrated here, and the four pairs correspond to two pairs for electric signal input and two pairs for electric signal output. In general, the common mode filter is often provided to the two pairs for output, but may be provided to the two pairs for input depending on the purpose. In addition, those differential signal lines 11 are covered with the common cover conductor pattern 14. That is, the cover conductor pattern 14 may cover not only a part of one pair of differential signal lines 11, but also a plurality of pairs of differential signal lines 11, or may cover a part of the differential signal lines 11 not provided with the common mode filter 800. In the ninth embodiment, the cover conductor pattern 14 is illustrated on the front surface layer for the sake of easier description, but, in an actual case, another pattern layer may be formed on the cover conductor pattern 14.

In addition, as already described above, the common mode filter 800 has a filter region provided at a position close to the signal processing circuit 30. Thus, the common mode filter 800 contributes to suppressing the common mode noise included in the input or output signal that passes through the differential signal line 11, thereby achieving stable communication quality.

In the ninth embodiment described above, an example in which the common mode filter 800 is provided between the signal processing circuit 30 in the optical transceiver 900 and the pad for electrical connection to various devices such as a router and a network switch is described, but the common mode filters 100 to 800 according to the respective embodiments disclosed herein are not limited to those usage examples, and may be suitably used in a differential signal line that provides connection among a driver element, an amplifier element, and a digital electric element or any other differential signal lines.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A common mode filter, comprising:
a pair of differential signal lines formed in a multilayer substrate including a dielectric layer;
a ground conductor formed in a layer below the pair of differential signal lines;
a resonant conductor pattern formed in one of the same layer as the ground conductor or a layer above the ground conductor, the resonant conductor pattern covering partial regions of the pair of differential signal lines in plan view and being connected to the ground conductor; and
a cover conductor pattern formed in a layer above the pair of differential signal lines, the cover conductor pattern covering the resonant conductor pattern in plan view and being connected to the ground conductor.

2. The common mode filter according to claim 1, wherein the resonant conductor pattern includes a plurality of patterns that are different from each other in one of a geometric shape or a connection position relative to the ground conductor.

3. The common mode filter according to claim 2, wherein, in any two patterns included in the plurality of patterns, a distance in plan view between a connection position to the ground conductor in one pattern and a connection position to the ground conductor in another pattern is shorter than ⅜ of a resonant wavelength of each of the two patterns.

4. The common mode filter according to claim 2, wherein one pattern and another pattern included in the plurality of patterns are formed in layers different from each other, and have at least parts overlapping each other in plan view.

5. The common mode filter according to claim 2, wherein one pattern included in the plurality of patterns is formed in a layer below the pair of differential signal lines, and another pattern included in the plurality of patterns is formed in a layer above the pair of differential signal lines.

6. The common mode filter according to claim 5, wherein the one pattern is connected to the ground conductor through a via, and the another pattern is connected to the cover conductor pattern through a via.

7. The common mode filter according to claim 1, further comprising a sub-ground conductor pattern formed in the same layer as the resonant conductor pattern, the sub-ground conductor pattern surrounding the resonant conductor pattern and being connected to the ground conductor,
wherein the resonant conductor pattern is separated from the sub-ground conductor pattern with an insulating gap provided therebetween, and is isolated from the sub-ground conductor pattern within the same layer.

8. The common mode filter according to claim 1, further comprising a sub-ground conductor pattern formed in the same layer as the resonant conductor pattern, the sub-ground conductor pattern surrounding the resonant conductor pattern and being connected to the ground conductor,
wherein the resonant conductor pattern is separated from the sub-ground conductor pattern with an insulating gap provided therebetween, and is connected to the sub-ground conductor pattern at least in one side of the resonant conductor pattern.

9. The common mode filter according to claim 1, wherein the resonant conductor pattern is formed in the same layer as the ground conductor, is separated from the ground conductor with an insulating gap provided therebetween, and is connected to the ground conductor at least in one side of the resonant conductor pattern.

10. The common mode filter according to claim 1, wherein the number of connection portions between the cover conductor pattern and the ground conductor is larger than the number of connection portions between the resonant conductor pattern and the ground conductor.

11. The common mode filter according to claim 1, wherein each of the pair of differential signal lines has one end connected through a via to a surface mounting terminal formed on a front surface layer of the multilayer substrate, and another end connected through a via to an external connection terminal formed on at least one of the front surface layer or a back surface layer of the multilayer substrate.

12. The common mode filter according to claim 11, wherein a length obtained by adding, to a distance in plan view between the via connecting each of the pair of differential signal lines and the surface mounting terminal to each other and a connection position between the resonant conductor pattern and the ground conductor, a distance in side view between each of the pair of differential signal lines and the surface mounting terminal is shorter than ⅜ of a resonant wavelength of the resonant conductor pattern.

13. An optical transceiver, comprising:
a common mode filter including:
a pair of differential signal lines formed in a multilayer substrate including a dielectric layer;
a ground conductor formed in a layer below the pair of differential signal lines;
a resonant conductor pattern formed in one of the same layer as the ground conductor or a layer above the ground conductor, the resonant conductor pattern covering partial regions of the pair of differential signal lines in plan view and being connected to the ground conductor; and
a cover conductor pattern formed in a layer above the pair of differential signal lines, the cover conductor pattern covering the resonant conductor pattern in plan view and being connected to the ground conductor,
each of the pair of differential signal lines having one end connected through a via to a surface mounting terminal formed on a front surface layer of the multilayer substrate, and another end connected through a via to an external connection terminal formed on at least one of the front surface layer or a back surface layer of the multilayer substrate;
a signal processing circuit mounted on the multilayer substrate via the surface mounting terminal;
a photoelectric conversion circuit which is mounted on the multilayer substrate, and is connected to the signal processing circuit; and
an optical fiber connector optically connected to the photoelectric conversion circuit.

14. An optical transceiver, comprising:
a common mode filter including:
a pair of differential signal lines formed in a multilayer substrate including a dielectric layer;
a ground conductor formed in a layer below the pair of differential signal lines;
a resonant conductor pattern formed in one of the same layer as the ground conductor or a layer above the ground conductor, the resonant conductor pattern covering partial regions of the pair of differential signal lines in plan view and being connected to the ground conductor; and
a cover conductor pattern formed in a layer above the pair of differential signal lines, the cover conductor pattern covering the resonant conductor pattern in plan view and being connected to the ground conductor,
each of the pair of differential signal lines having one end connected through a via to a surface mounting terminal formed on a front surface layer of the multilayer substrate, and another end connected through a via to an external connection terminal formed on at least one of the front surface layer or a back surface layer of the multilayer substrate,
the common mode filter having a length obtained by adding, to a distance in plan view between the via connecting each of the pair of differential signal lines and the surface mounting terminal to each other and a connection position between the resonant conductor pattern and the ground conductor, a distance in side view between each of the pair of differential signal lines and the surface mounting terminal, the length being shorter than ⅜ of a resonant wavelength of the resonant conductor pattern;
a signal processing circuit mounted on the multilayer substrate via the surface mounting terminal;
a photoelectric conversion circuit which is mounted on the multilayer substrate, and is connected to the signal processing circuit; and
an optical fiber connector optically connected to the photoelectric conversion circuit.
